(19) United States
(12) Patent Application Publication
(10) Pub. No.: US 2014/0324719 A1
(43) Pub. Date: Oct. 30, 2014

(54) SOCIAL MEDIA SCREENING AND ALERT SYSTEM

(71) Applicant: Bruce A. Canal, Plainfield, IN (US)

(72) Inventor: Bruce A. Canal, Plainfield, IN (US)

(21) Appl. No.: 14/323,621

(22) Filed: Jul. 3, 2014

Related U.S. Application Data
(63) Continuation-in-part of application No. 14/217,324, filed on Mar. 17, 2014.
(60) Provisional application No. 61/793,669, filed on Mar. 15, 2013.

(51) Int. Cl. G06Q 50/00; G06F 17/30

(52) U.S. Cl. CPC G06Q 50/01; G06F 17/30634
USPC 705/319

(57) ABSTRACT

A social media screening and alert method includes obtaining access to a first user's social media account. A text-based post is received from the first user's social media account. It is ascertained that an action verb from the text-based post is on a stored list of verbs. Found within a predetermined number of words of the action verb is either a noun identifying at least one person, or a time of day or time period. In response to the finding step, an electronic alert is transmitted to a second user.

### RELATED APPLICATIONS

The present application is a continuation-in-part of U.S. application Ser. No. 14/217,324, filed Mar. 17, 2014, entitled “Social Media Screening and Alert System,” which is a nonprovisional application of, and claims priority to, U.S. Provisional Application No. 61/793,669, filed Mar. 15, 2013, entitled “Social Media Screening and Alert System.” The above two patent applications are hereby incorporated by reference herein in their entireties.

### SUMMARY OF THE INVENTION

The present invention may provide an apparatus and method for protecting persons from bullying and violence, particularly children in schools. However, the invention may also be applied to subscribers who are on probation or parole, people who need to have their physical or mental health monitored, employees of businesses, and students in post-secondary education. The invention may include scanning social media websites, such as Facebook and Twitter, for preselected words or phrases stored in a proprietary database, analyzing how those preselected words or phrases interrelate with other words or phrases that appear nearby in the same posting, and, upon identifying such interrelated words and phrases, generates an output. Persons may subscribe to an inventive web-based application, and the application is then installed on the subscribers' social media accounts. In use, the application may scan a subscribing user's social media account for those preselected stored words or phrases and, when certain predetermined interrelationships between the words and/or phrases are identified, the application may generate an output.

The invention may include novel algorithms that can recognize slang, shortened words and abbreviations, and thereby discern the spirit of the phrase in order to reduce the number of false positives.

In one embodiment, the invention comprises a social media screening and alert method including obtaining access to a first user's social media account. A text-based post is received from the first user's social media account. It is ascertained that an action verb from the text-based post is on a stored list of verbs. Found within a predetermined number of words of the action verb is either a noun identifying at least one person, or a time of day or time period. In response to the finding step, an electronic alert is transmitted to a second user.

In another embodiment, the invention comprises a social media screening and alert method, including obtaining access to a first user's social media account. A text-based post is received from the first user's social media account. A degree to which the post is indicative that the first user anticipates that a person will be harmed is estimated. A second user is enabled to set a condition under which the second user will receive an electronic alert signal. The condition is the estimated degree to which the post is indicative that the first user anticipates that a person will be harmed being above a threshold value.

In yet another embodiment, the invention comprises a social media screening and alert method, including obtaining access to a first user's social media account, and receiving a text-based post from the first user's social media account. Words in the text-based post are compared to a list of trigger words. It is determined that the text-based post includes a cluster of consecutive words such that more than a threshold percentage of the consecutive words are trigger words. In response to the determining step, an electronic alert is transmitted to a second user.

An advantage of the invention is that it may enable persons or officials who have been notified to take affirmative action in an attempt to prevent possible tragedy and protect subscribers and other persons from possible harm.

Another advantage is that a user may set a level of seriousness of the danger indicated by the postings above which he will receive an alert message. Thus, the user may control the number of alert messages he receives and must review, thereby avoiding being inundated with more alert messages than he has the capacity to handle.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a flow chart illustrating one embodiment of a social media screening and alert method of the present invention;

FIG. 2 is a flow chart illustrating the sign-on process of the method of FIG. 1;

FIG. 3 is a flow chart illustrating the message retrieval step of the monitoring process of the method of FIG. 1;

FIG. 4 is a flow chart illustrating the message scan step of the monitoring process of the method of FIG. 1; and

FIG. 5 is a flow chart illustrating the alert process of the method of FIG. 1.

Corresponding reference characters indicate corresponding parts throughout the several views. Although the drawings represent embodiments of the present invention, the drawings are not necessarily to scale and certain features may be exaggerated in order to better illustrate and explain the present invention. Although the exemplification set out herein illustrates embodiments of the invention, in several forms, the embodiments disclosed below are not intended to be exhaustive or to be construed as limiting the scope of the invention to the precise forms disclosed.

### DETAILED DESCRIPTION

The embodiments hereinafter disclosed are not intended to be exhaustive or limit the invention to the precise forms disclosed in the following description. Rather the embodiments are chosen and described so that others skilled in the art may utilize its teachings.

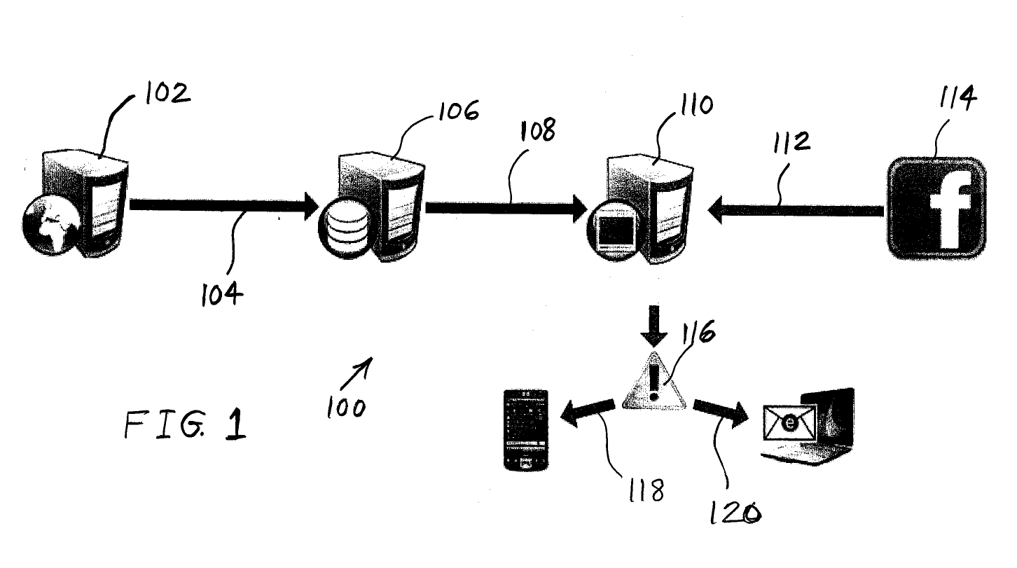

Referring first to FIG. 1, there is shown one embodiment of a social media screening and alert method 100 of the present invention. In a first step, a student or other subscriber may sign up or sign on for registration to the inventive application on a website at 102. As indicated at 104, the registration may be stored in a database server 106. As indicated at 108, a list of the subscribers to be monitored is fed to an inventive application in an application server 110. As indicated at 112, the application draws or imports text-based posts to scan from a social media website 114, such as Facebook, Twitter, etc. If it is determined that the scanned posts are indicative of plans for someone to be harmed, then a warning or alert message 116 is output and transmitted to authorities, law enforcement officials, parents, supervisors, etc., via text messages, as indicated at 118, or via email, as indicated at 120. Outputs 118, 120 can take the form of alerts to parents, school or law enforcement officials, or the like. The alerts can also take various forms, including but not limited to electronic messages, text messages, telephone, and the like. The alerts may be received on any communication device because application server 110 is web-based.

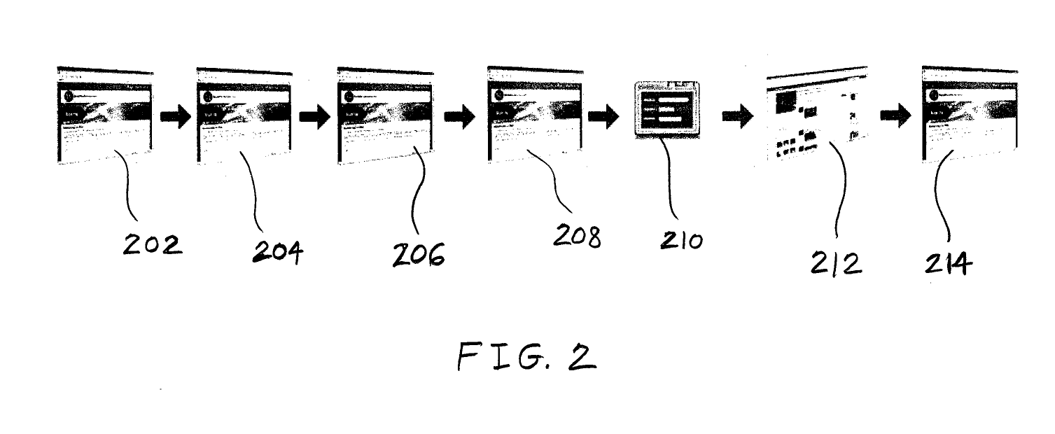

FIG. 2 is a flow chart illustrating the above-mentioned process of signing up or signing on for registration to the inventive application on the website at 102. In a first step 202, a student or other subscriber arrives at a sign-on page. In a second step 204, a student identifies himself and his school on the website. In a third step 206, the student's parent's personal identification, such as the parent's name and contact information, is entered into the website. The student or the parent may enter the identification information. In a fourth step 208, the student or parent accepts the terms of service. In a fifth step 210, the student signs on to Facebook. In a sixth step 212, the student grants the inventive application access to his Facebook account. Parents of subscribing students can grant permission for the inventive application to be attached to the student's Facebook account. In a seventh and final step 214, the student receives confirmation of his sign-on, perhaps as an email to his email account.

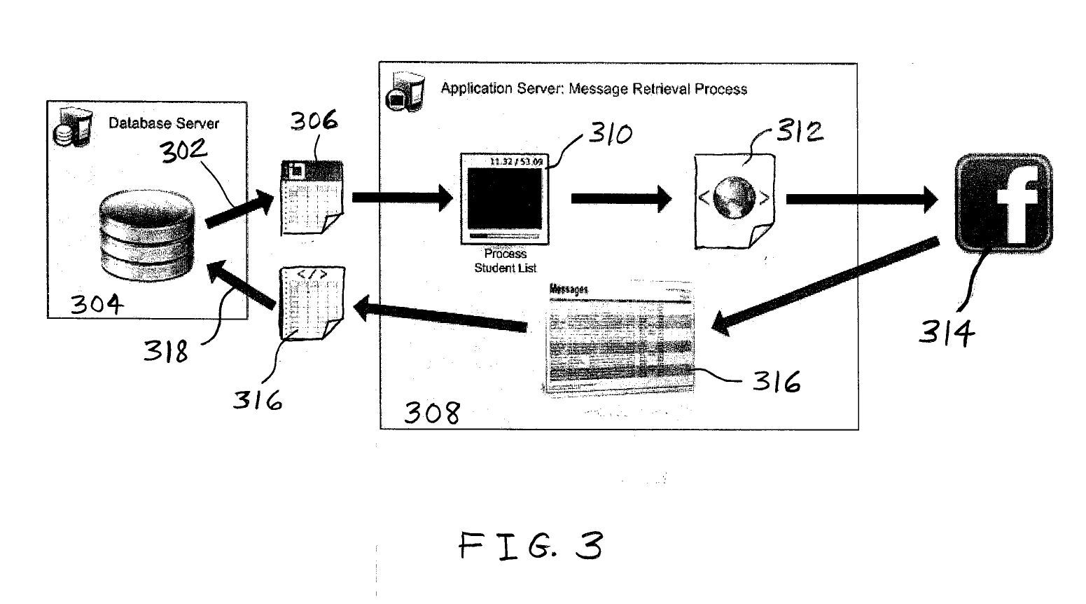

FIG. 3 illustrates the message retrieval step of the monitoring process of the invention. As indicated at 302, a database server 304 compiles a list 306 of students who have subscribed to the inventive service. The list of subscriber students may be transmitted to an application server 308 which performs a message retrieval. More particularly, application server 308 processes the student list, as indicated at 310, to thereby create an http request 312. The http request 312 is transmitted to a social media website 314, such as Facebook or Twitter. In response to the request, Facebook transmits posts and messages 316 back to application server 308. Application server 308 then saves posts and messages 316 in database server 304, as indicated at 318.

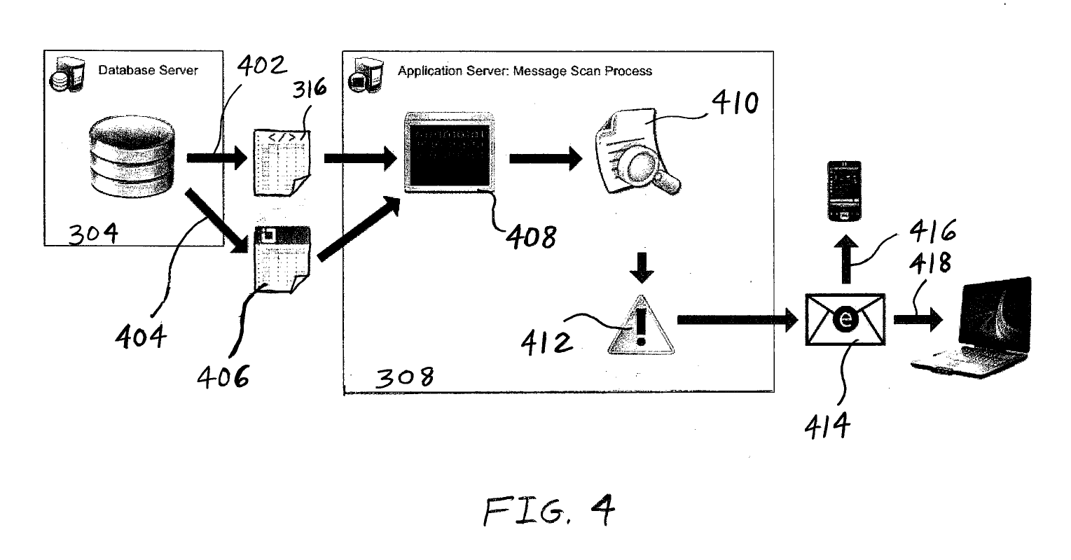

FIG. 4 illustrates the message scan step of the monitoring process of the invention. As indicated at 402, database server 304 transmits posts and messages 316 to application server 308. As indicated at 404, database server 304 transmits a list 406 of words and phrases to application server 308. The words and phrases on list 406 may be predetermined and/or selected by a user and stored manually in server 304. Words and phrases may be selected for inclusion on list 406 by virtue of being threatening of some kind of harm to some person. For example, action verbs such as “kill”, “shoot” and “stab” may be included in a list of threatening action verbs. Nouns that are associated with physical harm, such as “suicide,” “blood” and “death” may also be included on the list. Words such as “fire,” may be considered threatening as either a verb or a noun, and so may be included on both the list of verbs and the list of nouns. The list may also include phrases that include words that are not individually threatening, but are threatening when used together in a phrase. Such phrases may include “teach them a lesson,” “teach him a lesson,” “get even with them/him/her,” “make them/him/her sorry,” and “he/she/they will be sorry,” for example.

As indicated at 408, application server 308 may process messages 316 together with the list 406 of words and phrases to look for. More particularly, as indicated at 410, application server 308 may loop through and scan messages 316 for words and phrases included on list 406. If one of the key words and/or phrases in list 406 are found in messages 316, as indicated at 412, then an alert message 414 may be transmitted as a text message, as indicated at 416, or as an email, as indicated at 418, to a person or entity that is an authority over, or who supervises, the author of the message 316 that included the offending word and/or phrase.

Instead of, or in addition to, using and processing the list 406 of threatening words and/or phrases, application server 308 may run an algorithm that determines whether a group of words, or a phrase, is indicative of harm to a person. In one particular embodiment, application server 308 may ascertain that an action verb from the text-based message or post is on a stored list of verbs. Then application server 308 may search, within a predetermined number of words of the action verb, for either a noun identifying at least one person; or a time of day or time period. In response to finding both the action verb and the noun or time indication nearby the action verb, application server 308 may transmit an electronic alert to a second user, such as the authority or supervisor of the author of the message 316 that included the offending word and/or phrase. Thus, the algorithm is not limited to ascertaining that a single word, or string of consecutive words, matches a word or string of words on a predetermined list. Rather, the algorithm may find associated words of interest or clusters of words of interest within predetermined “distances” (e.g., within a number of words) of each other to thereby determine that the text as a whole may be threatening, regardless of the content of the words that are in-between the words of interest or clusters of words of interest.

The algorithm may also include multiple consecutive filters that a text-based post may pass through in order to generate an alert signal. For example, a first filter may include determining that one or more individual trigger words or flagrant words are included in the post. Such trigger words or flagrant words may be any part of speech, but in one embodiment are nouns and verbs. For example, nouns such as “blood,” “guts,” “mayhem,” etc., may be triggering nouns. Verbs such as “kill,” “maim,” “shoot,” etc., may be triggering verbs.

Having identified a post, or a paragraph or other subset of a post including a trigger word, the post or paragraph may be extracted for scanning within the inventive application. A second filter may scan the post or paragraph to analyze the sentence structure of which the trigger word(s) is/are a part. For example, if the trigger word is a noun, then the second filter may verify that the sentence or phrase containing the noun trigger word also includes a verb or time reference that relates to the noun trigger word. As a more particular example, if the trigger word is “mayhem” then a matching verb, such as “cause,” a matching time reference, such as “tomorrow,” or a matching location, such as “the school,” may also be found in the sentence or phrase, thereby providing specificity and confirming that the trigger word “mayhem” is indeed indicative of someone being in potential danger. As another example, if the trigger word is a verb, then the second filter may verify that the sentence or phrase containing the verb trigger word also includes a noun, time reference, or location reference that relates to the verb trigger word. As another more particular example, if the trigger word is “kill” then a matching noun, such as “them,” or a matching time reference, such as “soon,” or a matching location reference, such as “Northview Mall,” may also be found in the sentence or phrase, thereby providing specificity and confirming that the trigger word “kill” is indeed indicative of someone being in potential danger.

Having identified a trigger word in the first filter and having identified in the second filter sentence structure that confirms the danger indicated by the trigger word, a third filter may analyze the entire post or paragraph in order to quantify the level of danger indicated by the post. A user may set a threshold value of the danger level below which he will not receive an alert message and above which he will receive an alert message. The level of danger indicated by the post may be quantified based upon any criteria within the scope of the invention. In one embodiment, the level of danger indicated by the post may be quantified based upon one or more criteria, including completeness of the sentence structure; the number of trigger words in the paragraph/posting; a percentage of words in the paragraph/posting that are trigger words; whether specific individuals are named; whether a specific time is named; whether a weapon is named; whether drugs are mentioned; whether feelings of animosity are expressed (e.g., forms of the word “hate”); whether profane language is included; and whether an escape plan is alluded to (e.g., driving away, suicide, barricading). The number of levels of danger estimated to be indicated by the post may be settable by a user. The quantified level of danger indicated by the post may be included in the subject line of an alert email to an authority so that the authority may see the quantification before opening the email and may judge whether to open the email and how soon to open the email based on the quantification.

The “completeness of the sentence structure” criterion mentioned above may depend upon the number of parts of speech that are included in a posted sentence. For example, a sentence including the five elements of a subject, a verb, a direct object, a time reference and a location reference may be considered a sentence having a complete structure. Sentences having four of these five elements may be weighted more heavily than sentences having a lesser number of these five elements, etc.

In another embodiment, a user may choose to receive an alert message in the case where no individual posting has a danger value that meets his threshold for an individual posting, but multiple postings within a certain (possibly predetermined) time period have a cumulative danger value exceeding a cumulative threshold value that the user may set. For example, a user may choose to receive an alert message if an individual posting has a danger value of at least 4 out of a maximum value of 5, and may also choose to receive an alert message if the cumulative danger values of an individual's postings within a twenty-four hour period total 7 or more.

In yet another embodiment, a user may choose to receive an alert message in the case where no individual posting has a danger value that meets his threshold for an individual posting, but multiple postings within a certain (possibly predetermined) time period include the same trigger words, which may indicate that the author has premeditated a plan to do harm and is not merely temporarily emotionally upset. For example, a user may choose to be alerted if a student has postings that both include a same trigger word, such “AK-47,” within a 72 hour time period.

In one embodiment, a user may select a setting such that a text-based post generates an alert signal by virtue of passing through all three of the above-described filters. In another embodiment, however, a user may choose that a text-based post generates an alert signal by virtue of passing through a majority of the filters employed by the algorithm (e.g., passing two out of three filters will result in an alert signal being generated).

Non-action verbs, such as “is” or “are,” for example, may be distinguished from action verbs by the algorithm. Such non-action verbs may be ignored or not counted as trigger words.

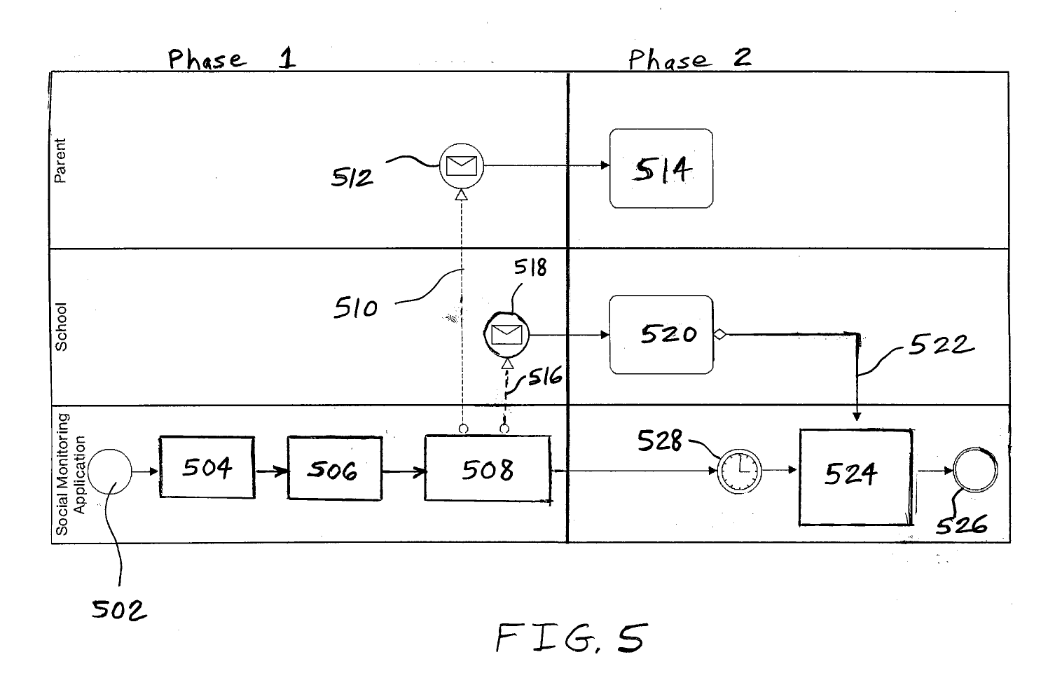

FIG. 5 is a flow chart illustrating the alert process of the method of FIG. 1 in which a first phase may be characterized by detecting suspicious posts and notifying authorities. In a second phase, the authorities may investigate the situation and/or view the posts or alerts, and thereby the alert is resolved. The alert process of FIG. 5 may be applied to the case of school authorities and/or a parent being notified in the event that threatening words and/or phrases are detected in a social media posting. After a start 502 of a first phase of the alert process, a student's social media website accounts are monitored at 504. For example, application server 308 may perform such monitoring.

Next, at 506, trigger words and phrases are scanned for in the text postings in the student's social media website accounts. For example, application server 308 may search for words and/or phrases, or clusters of words and/or phrases that are nearby each other in the text, and together are determined to be indicative of the student anticipating some harm being done to another person, or some harm being done to the student himself.

In a next step 508, the trigger words and phrases scanned for at 506 are found. In response to finding the trigger words and phrases, the student's parents are notified, as indicated at 510, such as by email 512, that their child has posted some text from which it may be deduced that the child or one or more other children may soon be in danger. In response to receiving the notification, at 514 one or both of the parents may login to a website dedicated to an application of the present invention and view alert messages and perhaps their child's posts that were deemed indicative of danger.

Also in response to finding the trigger words and phrases, administrators at the school that the student attends are notified, as indicated at 516, such as by email 518, that the student has posted some text from which it may be deduced that the child or one or more other children may soon be in danger. In response to receiving the notification, at 520 one or more of the administrators may login to the website dedicated to an application of the present invention and acknowledge alert messages and perhaps the student's posts that were deemed indicative of danger. The acknowledgement of the alert message may be transmitted, as indicated at 522, to application server 308. In response to receiving the acknowledgement, application server 308 may close the alert, as at 524, and the second phase is ended at 526. However, if no acknowledgement is received within some predetermined time period (e.g., seventy-two hours) after notifications 512, 518 are sent, as determined at 528, then application server 308 may close the alert, as at 524, and the second phase is ended at 526.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A social media screening and alert method, comprising the steps of:
obtaining access to a first user's social media account;
receiving a text-based post from the first user's social media account;
ascertaining that an action verb from the text-based post is on a stored list of verbs;
finding within a predetermined number of words of the action verb:
a noun identifying at least one person; or
a time of day or time period; and
in response to the finding step, transmitting an electronic alert to a second user.

2. The method of claim 1 wherein the second user is an authority.

3. The method of claim 1 comprising the further step of ignoring nonaction verbs within the predetermined number of words of the action verb.

4. The method of claim 1 comprising the further step of quantifying a level of danger indicated by the post to the at least one person.

5. The method of claim 4 wherein the electronic alert is transmitted to the second user only if a number assigned to the a level of danger indicated by the post to the at least one person exceeds a threshold number.

6. The method of claim 4 wherein the quantification is dependent upon a completeness of a structure of a sentence including the action verb.

7. The method of claim 4 wherein the electronic alert comprises an email, the quantification being included in a subject line of the email.

8. A social media screening and alert method, comprising the steps of:
accessing a first user's social media account;
obtaining a text-based post from the first user's social media account;
estimating a degree to which the post is indicative that the first user anticipates that a person will be harmed; and
enabling a second user to set a condition under which the second user will receive an electronic alert signal, the condition comprising the estimated degree to which the post is indicative that the first user anticipates that a person will be harmed being above a threshold value.

9. The method of claim 8 wherein the estimating step includes assigning one of a plurality of levels to the estimated degree, the set condition comprising the estimated degree being assigned at least a predetermined one of the levels.

10. The method of claim 9 further comprising enabling the second user to set a number of levels included in the plurality of levels.

11. The method of claim 8 wherein the second user receives the electronic alert signal only if the text-based post includes a predetermined number of trigger words.

12. The method of claim 11 wherein the second user receives the electronic alert signal only if a sentence or phrase including at least one of the trigger words also includes:
a time reference corresponding to the one of the trigger words;
if the one of the trigger words is a noun, then a verb corresponding to the one of the trigger words, or
if the one of the trigger words is a verb, then a noun corresponding to the one of the trigger words.

13. The method of claim 8 wherein the estimating step is dependent upon whether a specific individual is named in the post and whether a specific time or time period is referenced in the post.

14. The method of claim 8 wherein the estimating step is dependent upon whether a weapon is named in the post, whether drugs are mentioned in the post, and whether profane language is included in the post.

15. A social media screening and alert method, comprising the steps of:
obtaining access to a first user's social media account;
receiving a text-based post from the first user's social media account;
comparing words in the text-based post to a list of trigger words;
determining that the text-based post includes a cluster of consecutive words such that more than a threshold percentage of the consecutive words are on the list of trigger words; and
in response to the determining step, transmitting an electronic alert to a second user.

16. The method of claim 15 comprising the further step of ascertaining that a number of the consecutive words exceeds a threshold number of words, the transmitting step being dependent upon the ascertaining step.

17. The method of claim 15 comprising the further steps of:
estimating a level of danger associated with the text-based post; and
enabling the second user to set a condition under which the second user will not receive the electronic alert signal, the condition comprising the estimated level of danger being below a threshold level.

18. The method of claim 17 wherein the estimated level of danger is dependent upon a completeness of a structure of a sentence included in the text-based post.

19. The method of claim 15 wherein the second user receives the electronic alert signal only if a sentence or phrase including at least one of the trigger words also includes a time reference corresponding to the one of the trigger words.

20. The method of claim 15 wherein the second user receives the electronic alert signal only if a sentence or phrase including at least one of the trigger words also includes:
a verb corresponding to the one of the trigger words if the one of the trigger words is a noun; or.
a noun corresponding to the one of the trigger words if the one of the trigger words is a verb.
